(19) United States
(12) Patent Application Publication
(10) Pub. No.: US 2026/0137064 A1
(43) Pub. Date: May 21, 2026

(54) SENSING PEST AND POLLINATORS USING METAMATERIALS

(71) Applicants: BOARD OF REGENTS, THE UNIVERSITY OF TEXAS SYSTEM, Austin, TX (US); THE UNITED STATES OF AMERICA, AS REPRESENTED BY THE SECRETARY OF AGRICULTURE, Washington, DC (US)

(72) Inventors: Tahsin KHAJAH, Tyler, TX (US); Katherine A. PARYS, Stoneville, MS (US); Gadi V. REDDY, Stoneville, MS (US)

(73) Assignees: BOARD OF REGENTS, THE UNIVERSITY OF TEXAS SYSTEM, Austin, TX (US); THE UNITED STATES OF AMERICA, AS REPRESENTED BY THE SECRETARY OF AGRICULTURE, Washington, DC (US)

(21) Appl. No.: 19/327,079

(22) Filed: Sep. 12, 2025

Related U.S. Application Data
(60) Provisional application No. 63/721,254, filed on Nov. 15, 2024.

(51) Int. Cl. A01K 47/00; A01K 29/00; A01K 49/00

(52) U.S. Cl. CPC A01K 47/00; A01K 29/005; A01K 49/00; A01K 2227/706

(57) ABSTRACT

According to some embodiments, a method for sensing a target frequency of an insect is provided. The method includes obtaining an acoustic signal comprising a plurality of frequencies, wherein the plurality of frequencies includes the target frequency. The method includes isolating the target frequency from the plurality of frequencies using a metamaterial. The method includes sensing the target frequency of the insect based on the isolating.

### CROSS REFERENCE TO RELATED APPLICATIONS

This application claims the benefit of priority to U.S. Provisional Application Ser. No. 63/721,254 filed Nov. 15, 2024, the disclosure of which is incorporated herein in its entirety by reference.

### STATEMENT OF GOVERNMENT SUPPORT

This invention was made with U.S. Government support under agreement number 58-6066-3-030 awarded by the U.S. Department of Agriculture. The U.S. Government has certain rights in this invention.

### TECHNICAL FIELD

Aspects of the present disclosure relate to sensing a target frequency associated with an insect using a metamaterial.

### BACKGROUND

Insects play a vital role in agriculture, either damaging the crops as pests or serving as essential pollinators and natural pest controllers. Many of the world's most important food crops, including fruits, vegetables, and nuts, rely on insect pollination and suffer from pest infestation. Pollinators, such as bees, butterflies, and certain beetles, are crucial for the fertilization process as they facilitate the transfer of pollen between flowers. To develop sustainable agriculture and reduce the blind use of pesticides, which also damages useful species, it is essential to identify the pollinator species, their distribution in the field and study their health and behavior. On the other hand, early identification of pests allows targeted treatments, and avoids wide-spread damage and reduces the amount pesticide use. Additionally, one cannot underestimate the negative effects of the blind application of pesticide as it eliminates various predatory and parasitic insects that help manage pest populations naturally, reducing the need for chemical pesticides and promoting healthier ecosystems. Further supporting sustainable agricultural practices, the presence of beneficial insects also contributes to soil health and nutrient cycling. In addition to presence monitoring and identification of insect species, it is also important to monitor their health and behavior for early intervention and treatment.

Recently, however, a significant decline in insect populations poses a serious threat to agriculture. Specifically, bees play a crucial role in pollinating many crops, and their decline can lead to reduced food production. The bee population has decreased due to several factors including the use of pesticides, habitat loss due to urbanization, reducing the availability of flowers and nesting sites, and the increasing impact of diseases and parasites. Maintaining the bee population, along with other insects, will require active monitoring by experts.

### SUMMARY

Conventional methods of monitoring insect populations require expensive recording equipment and extensive post processing (e.g., using machine learning) to isolate frequencies associated with an insect population from background noise. The overwhelming cost required of these conventional methods prevents users (e.g., farmers) from implementing insect monitoring at a large scale. As such, there is a need for a low-cost method for sensing specific frequencies associated with the presence of a species, its health, and behavior.

Aspects of the present disclosure relate to method for sensing a target frequency of an insect. The method includes obtaining an acoustic signal comprising a plurality of frequencies. The plurality of frequencies includes the target frequency. The method includes isolating the target frequency from the plurality of frequencies using a metamaterial. The method includes sensing the target frequency of the insect based on the isolating.

According to some embodiments, the insect is a species of bee.

According to some embodiments, the method further includes: identifying, in response to sensing the target frequency of the insect, at least one of: a location of the insect, a behavior associated with the insect, a species of the insect, a population of the insect, or a health condition associated with the insect.

According to some embodiments, isolating comprises isolating the target frequency in a zone of the metamaterial.

According to some embodiments, the method further includes: capturing the target frequency using a recording device. The recording device is positioned within the zone of the metamaterial.

According to some embodiments, isolating the target frequency comprises at least one of: amplifying the target frequency within the zone of the metamaterial and/or suppressing frequencies of the plurality of frequencies other than the target frequency.

According to some embodiments, a structure of the metamaterial passively isolates the target frequency.

According to some embodiments, the method further includes: isolating the target frequency using a second metamaterial, the second metamaterial is positioned a distance from the metamaterial.

According to some embodiments, the method further includes: mapping a distribution of the insect using the target frequency isolated by the metamaterial and the second metamaterial.

According to some embodiments, the acoustic signal is obtained from a geographical area.

According to some embodiments, the sensing the target frequency of the insect comprises determining that an amplitude of target frequency is greater than a threshold.

According to some embodiments, the method further includes: designing the metamaterial based on the target frequency.

According to some embodiments, the method further includes: designing the metamaterial was using iterative On Surface Radiation Conditions.

According to some embodiments, the method further includes: capturing a recording of the target frequency with a recording device; and transmitting the recording towards a computing device.

According to some embodiments, the metamaterial comprises a body and a target zone.

According to some embodiments, the body comprises a plurality of chambers that amplify the target frequency in the target zone.

According to some embodiments, the metamaterial comprises an array of columns and a target zone.

According to some embodiments, each column in the array of columns has an elliptical cross-section.

According to some embodiments, a definition or a location of each elliptical cross-section amplifies the target frequency in the target zone.

According to some embodiments, the target zone comprises a gap between a first column and a second column in the array of columns.

According to some embodiments, the plurality of frequencies includes a second target frequency and the method further includes: isolating the second target frequency from the plurality of frequencies using the metamaterial.

According to one aspect, a sensing device is provided. The device includes a metamaterial designed to isolate a target frequency corresponding to an insect.

According to some embodiments, the sensing device further includes: at least one of a recording device or a computing device.

According to some embodiments, the metamaterial is designed based on the target frequency.

According to some embodiments, the metamaterial is designed using iterative On Surface Radiation Conditions.

According to some embodiments, the metamaterial comprises a body and a target zone.

According to some embodiments, the body comprises a plurality of chambers that amplify the target frequency in the target zone.

According to some embodiments, the metamaterial comprises an array of columns and a target zone.

According to some embodiments, each column in the array of columns has an elliptical cross-section.

According to some embodiments, a definition or a location of each elliptical cross-section amplifies the target frequency in the target zone.

According to some embodiments, the target zone comprises a gap between a first column and a second column in the array of columns.

According to some embodiments, the metamaterial is designed to isolate a second target frequency corresponding to a second insect.

According to some embodiments, the metamaterial comprises a plurality of target zones including a first target zone associated with the target frequency and a second target zone associated with the second target frequency.

According to one aspect, a metamaterial designed to isolate a target frequency corresponding to an insect provided.

According to some embodiments, the metamaterial is designed based on the target frequency.

According to some embodiments, metamaterial is designed using iterative On Surface Radiation Conditions.

According to some embodiments, the metamaterial comprises a body and a target zone.

According to some embodiments, the body comprises a plurality of chambers that amplify the target frequency in the target zone.

According to some embodiments, the metamaterial comprises an array of columns and a target zone.

According to some embodiments, each column in the array of columns has an elliptical cross-section.

According to some embodiments, a definition or a location of each elliptical cross-section amplifies the target frequency in the target zone.

According to some embodiments, the target zone comprises a gap between a first column and a second column in the array of columns.

According to some embodiments, the metamaterial is designed to isolate a second target frequency corresponding to a second insect.

According to some embodiments, the metamaterial comprises a plurality of target zones including a first target zone associated with the target frequency and a second target zone associated with the second target frequency.

In another aspect, a computing device is provided. The computing device includes a processor. The computing device includes a computer program product storing instructions that, when executed by the processor, causes the computing device to perform a process comprising: obtaining an acoustic signal associated with an insect; and identifying, based on the acoustic signal, at least one of: a location of the insect, a behavior associated with the insect, a species of the insect, a population of the insect, or a health condition associated with the insect.

According to some embodiments, the acoustic signal is obtained from a recording device and the recording device is disposed within a target zone of a metamaterial.

According to some embodiments, the acoustic signal is obtained from another computing device.

According to some embodiments, the process includes generating a recording of the acoustic signal.

According to some embodiments, generating the recording of the acoustic signal comprises: determining an amplitude of the acoustic signal is greater than a threshold. The recording of the acoustic signal is generated as a result of the amplitude being greater than the threshold.

In another aspect, a computer program product is provided. The computer program product includes a non-transitory computer readable medium including computer readable instructions that, when executed by one or more processors, cause the one or more processors to perform any one of the methods described above.

### BRIEF DESCRIPTION OF THE DRAWINGS

The accompanying drawings, which are included to provide a further understanding of embodiments of the invention and are incorporated in and constitute a part of this specification, illustrate embodiments of the invention and together with the description serve to explain the principles of embodiments of the invention.

FIG. 1 illustrates a system, according to some embodiments.

FIG. 2 illustrates a system, according to some embodiments.

FIG. 3A illustrates a design of a metamaterial, according to some embodiments.

FIG. 3B illustrates an amplitude graph, according to some embodiments.

FIG. 4A illustrates a design of a metamaterial, according to some embodiments.

FIG. 4B illustrates an amplitude graph in response to a certain frequency, according to some embodiments.

FIG. 5 illustrates an amplitude graph in response to a certain frequency, according to some embodiments.

FIG. 6 is a flow diagram of a method, according to some embodiments.

FIG. 7 is a block diagram of an apparatus, according to some embodiments.

### DETAILED DESCRIPTION

Conventional methods to sense frequencies of insects are resource intensive and impractical to implement at scale. These methods may use expensive sensors linked to sophisticated custom-written software, machine learning models, and depend on often unavailable data sources specific to each insect type. Aspects of the present disclosure relate to sensing a target frequency of an insect using a metamaterial. The metamaterial may passively isolate the target frequency of an insect, allowing the frequency to be measured without expensive microphones or excessive post processing. Utilizing a recording device with a metamaterial reduces the overall cost of the device, reduces a dependency on custom software, reduces the use of post processing resources and machine learning, and reduces background noise captured by the recording device.

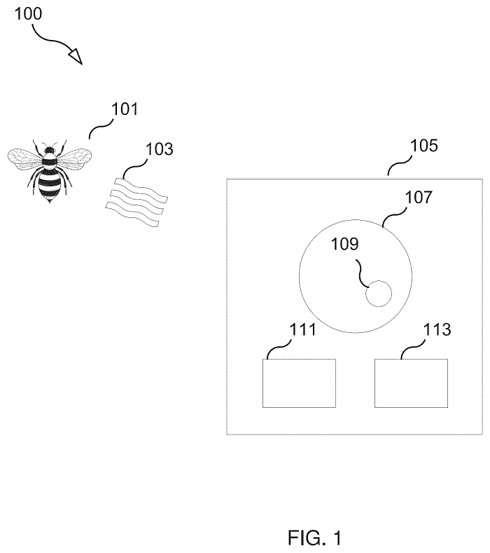

FIG. 1 illustrates a system, according to some embodiments. System 100 includes an insect 101, a sound wave 103, and a sensing device 105. Insect 101 is illustrated as a honeybee, but may be any other insect. In some embodiments, insect 101 may be an animal other than an insect, such as, but not limited to, birds. Insect 101 may generate sound wave 103 using one or more methods. For example, insect 101 may vibrate its wings or other body parts in the air, water, or other environment to generate sound wave 103. As another example, insect 101 may generate sound wave 103 by stridulation, the rubbing of two structures. Other non-limiting examples of a sound wave 103 may include, inter alia, tapping, buzzing, clicking, or a chirp, trill, lisp, zit, tsip, or rattle, among others. Sound wave 103 may include spectral and temporal signatures corresponding to presence, health, and/or behavior parameters of a targeted species. As an example, a honeybee may generate a sound which indicates a health status of the honeybee itself and a health status of its colony. As another example, acoustic signatures of bees are species dependent and have different spectral and temporal signatures that can be used to identify them. Furthermore, within one targeted species, clear association of acoustic signals with important behavioral patterns, health threats, and diseases exists that can be used for health monitoring and early infestation detection.

Sensing device 105 may be configured to record sound wave 103 produced by insect 101. Specifically, sensing device 105 may be configured to record a target frequency of sound wave 103. The target frequency may be associated with a presence, health, and/or behavior parameter of insect 101, among other parameters. In some embodiments, the target frequency may encompass a frequency range. Sensing device 105 may include a metamaterial 107, a recording device 111, and a computing device 113. In some embodiments, recording device 111 and computing device 113 may be a single device. Metamaterial 107 may be configured to receive sound wave 103. In some embodiments, metamaterial 107 may be disposed on an external surface of sensing device 105. In some embodiments, metamaterial 107 may comprise metal, wood, and/or a plastic material, among other materials or combinations of materials.

Metamaterial 107 may be configured to amplify targeted acoustic signatures of sound wave 103 while suppressing background noise. Specifically, as sound wave 103 impinges upon sensing device 105, metamaterial 107 may passively isolate the targeted frequency into a target zone 109. The structure of metamaterial 107 may be designed based on the target frequency. For example, sensing device 105 may be positioned in a field adjacent to a road. Metamaterial 107 may be designed so a frequency produced by honeybees is amplified within target zone 109 and other background noise (e.g., cars driving on the road) is suppressed.

Recording device 111 may be configured to record the target frequency within the target zone 109. In some embodiments, recording device 111 may be positioned within the target zone 109 or adjacent to the target zone 109. As discussed above, metamaterial 107 passively filters the target frequency from background noise. As such, recording device 111 may be embodied as a low-cost microphone as metamaterial 105 amplifies the target frequency within target zone 109 while suppressing background noise.

Computing device 113 may be configured to receive data from recording device 111. Computing device 113 may generate sound recordings of the target frequency based on the received data. In some embodiments, computing device 113 may determine a level of sound within target zone 109 and compare the level of sound to a threshold. As a result of the level of sound being above a threshold, computing device 113 may begin to collect data and/or generate a sound recording of the target frequency. Use of a threshold may improve performance, longevity, and/or reduce processing or memory requirements of one or more components of the sensing device 105. Use of a threshold may also help to identify events or data of interest.

As an example, an environment may naturally produce a variety of frequencies, including the target frequency. As such, a low level of sound may consistently be present within target zone 109. When insect 101 approaches sensing device 105, the level of sound within target zone 109 may increase greater than the threshold. Once the level of sound increases past the threshold, computing device 113 may begin to generate a sound recording of the target frequency. The sound recording may continue until the level of sound decreases below the threshold as the decreasing level of sound indicates insect 101 is no longer nearby sensing device 105. Computing device 113 may include metadata with the sound recording including, for example, time of the recording, location of sensing device 105, and a maximum level of sound within the sound recording.

The sound recordings may be analyzed by computing device 113 or another computing device. The sound recordings may be used to determine one or more parameters associated with insect 101. The one or more parameters may be presence, health, and/or behavior parameters, among other parameters. For example, the sound recording may be used to determine a frequency in which honeybees fly by sensing device 105. The frequency may be used to estimate a number of honeybees in a local bee population. The sound recordings, and sensing device 105, may be used for sensor design and development, by wildlife monitoring companies, agricultural research entities, and farmers, among others.

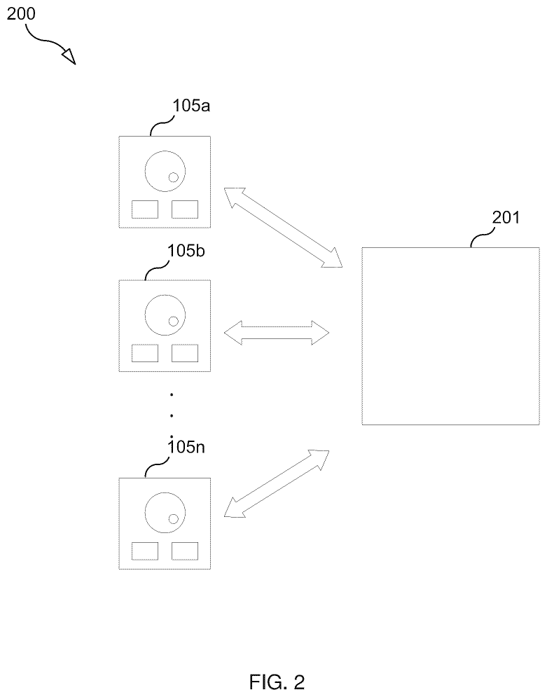

FIG. 2 illustrates a system, according to some embodiments. System 200 includes one or more sensing devices 105a-n and a central computing system 201. System 200 may enable a user to gather sensing data for insect 101 over an area. The one or more sensing devices 105a-n may be positioned a distance apart from each other. One or more of sensing devices 105a-n may transmit its sensing data and/or sound recordings to central computing system 201. In some embodiments, one or more sensing devices 105a-n may transmit the sensing data and/or sound recording using a wireless communication technology (e.g., Bluetooth, Wi-Fi). Central computing system 201 may obtain the sensing data and/or sound recordings from the plurality of sensing devices 105a-n and determine one or more attributes for the area. In some embodiments, central computing system 201 may estimate a population density of insect 101 and/or map its distribution over an area. For example, central computing system 201 may determine that a colony of bees in a first area may be suffering from an illness and that a colony of bees in a second area may be good health. In this example, a bee-keeper may quickly identify and isolate the sick colony in order to prevent the spread of the illness.

In some embodiments, each sensing device 105a-n of the one or more sensing devices 105a-n may be configured to detect the same target frequency. In some embodiments, a plurality of sensing devices 105a-n may include a first set of sensing devices designed to test a first target frequency and a second set of sensing devices designed to test a second target frequency. For example, a first set of sensing devices may be configured to detect a pest and a second set of sensing devices may be configured to detect a predator insect that consumes the pest. By analyzing the sound recordings, a farmer may determine whether pesticides are needed based on whether or not the predator insect is present or other parameters.

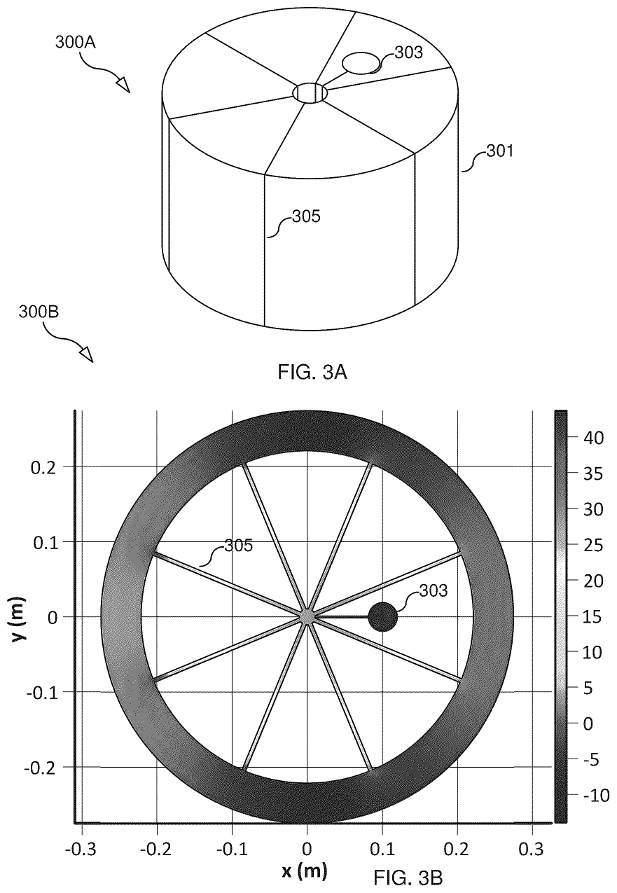

FIG. 3A illustrates a design of a metamaterial, according to some embodiments. In some embodiments, metamaterial 107 may be embodied as design 300A. Metamaterial design 300A includes a metamaterial body 301 and a target zone 303. In some embodiments, metamaterial body 301 may include a plurality of chambers 305. The structure of metamaterial body 301, including the structure of the plurality of chambers 305, may amplify a target frequency within target zone 303 when a sound wave impinges upon metamaterial body 301. FIG. 3B illustrates a amplitude graph for a target frequency, according to some embodiments. Amplitude graph 300B shows that the intensity of a target frequency is greatest within target zone 303 in metamaterial 107 embodied by metamaterial design 300A.

In some embodiments, metamaterial 105 may be designed using Iterative On Surface Radiation Conditions (ITOSRC). ITOSRC is a method for estimating the scattered field from arbitrarily shaped obstacles and allows a fast and reliable single-and multiple-scattering analyses in reduced spatial dimensions. Examples of ITOSRC are disclosed in International Application No. PCT/US23/80708, which is incorporated herein by reference in its entirety. A metamaterial design may comprise a target zone where the targeted frequency is isolated. To isolate the targeted frequency, the scattered field of the metamaterial design may be simulated multiple times using the ITOSRC method. With each simulation, the metamaterial design may be altered until the simulated scattered field illustrated that the targeted frequency was amplified in the target zone. As an example, referring back to FIG. 3A, the shape and position of target zone 303 and the plurality of chamber 305 may be modified with each iteration until the target frequency is successfully amplified in target zone 303.

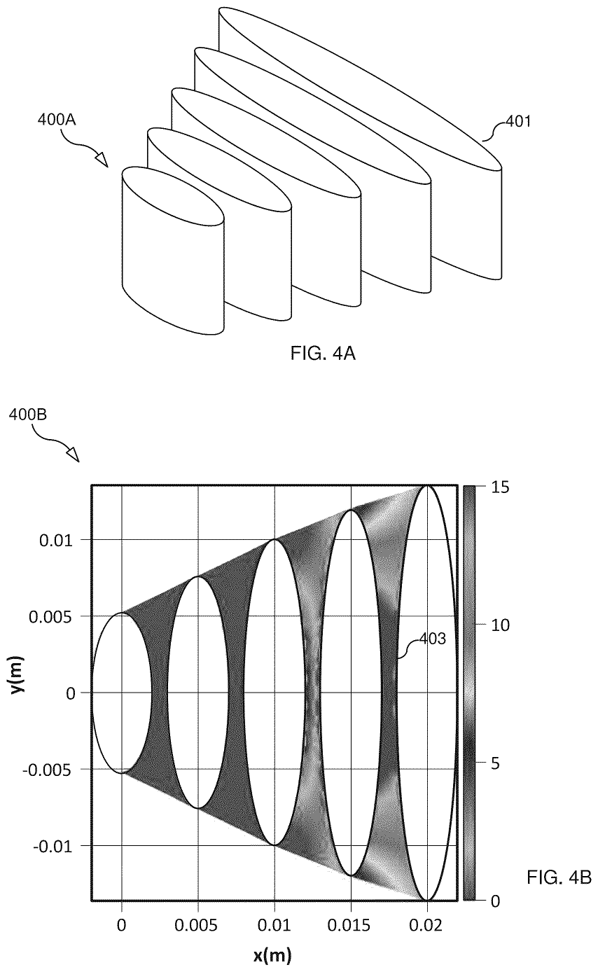

FIG. 4A illustrates a design of a metamaterial, according to some embodiments. In some embodiments, metamaterial 107 may be embodied as design 400A. Metamaterial design 400A includes an array of columns 401 with elliptical cross-sections. In some embodiments, metamaterial design 400A includes an array of columns 401 with rectangular cross-sections. The definition of each ellipse and its location may give rise to concentration of sound at certain gaps between specific columns. FIG. 4B illustrates a frequency graph, according to some embodiments. Frequency graph 400B shows that the structure of columns 401 results in an intensity of a target frequency being greatest within target zone 403 in metamaterial 107 embodied by metamaterial design 400A.

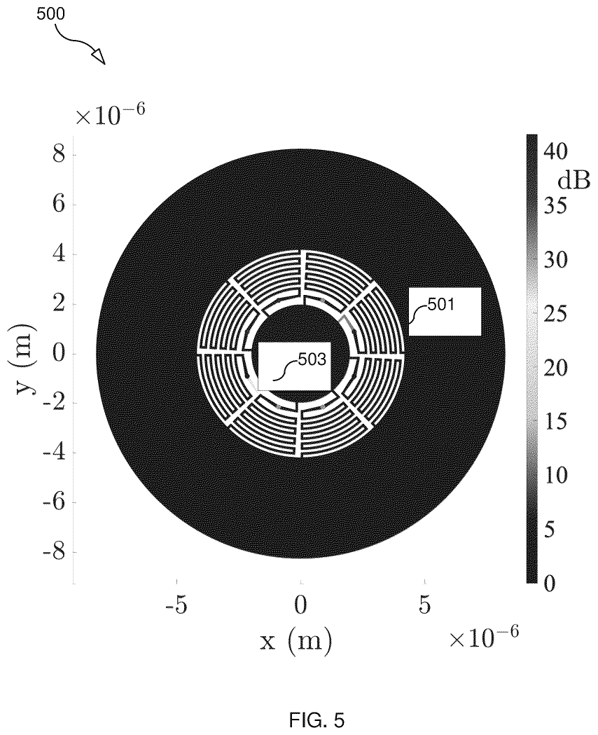

FIG. 5 illustrates a frequency graph of a design of a metamaterial, according to some embodiments. In some embodiments, metamaterial 107 may be embodied as design 500. Metamaterial design 500 includes a plurality of patterns 501. The definition of patterns 501 may give rise to concentration of sound at a plurality of target zones 503. Each pattern 501 may correspond to one target zone 503. As shown in FIG. 5, each target zone 503 encompasses the small circles surrounding the large central circle. enIn some embodiments, patterns 501 may be tuned to one or more frequencies such that target zones 503 correspond to one or more frequencies. For example, target zones 503 may include a first target zone associated with a first target frequency and a second target zone associated with a second target frequency, the first and second target zones being different. In this example, metamaterial 107 embodied by metamaterial design 500 may be configured to isolate multiple different target frequencies simultaneously.

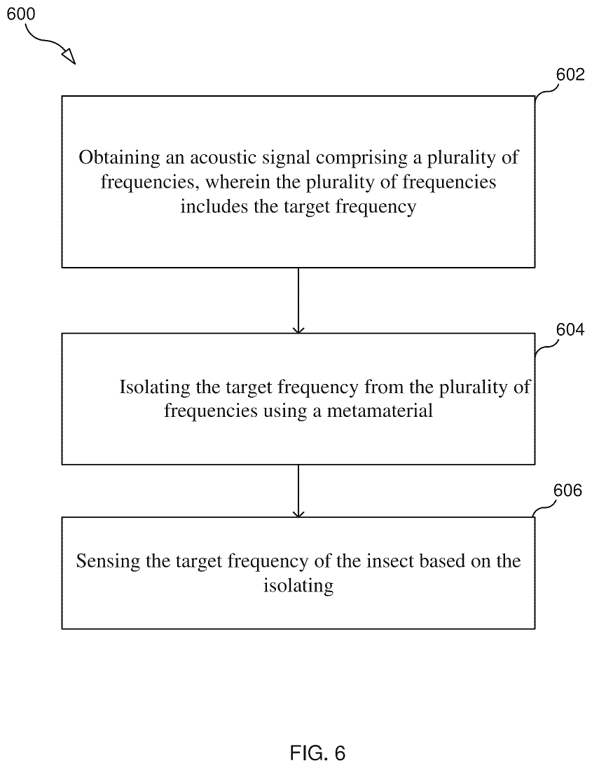

FIG. 6 is a flow diagram of a method 600, according to some embodiments. Method 600 is a method for sensing a target frequency of an insect. In some embodiments, method 600 is performed by apparatus 700, described below. Step 602 includes obtaining an acoustic signal comprising a plurality of frequencies, wherein the plurality of frequencies includes the target frequency. Step 604 includes isolating the target frequency from the plurality of frequencies using a metamaterial. Step 606 includes sensing the target frequency of the insect based on the isolating.

In some embodiments, the insect is a species of bee. In some embodiments, method 600 includes identifying, in response to sensing the target frequency of the insect, at least one of: a location of the insect, a behavior associated with the insect, a species of the insect, a population of the insect, or a health condition associated with the insect. In some embodiments, isolating comprises isolating the target frequency in a zone of the metamaterial.

In some embodiments, method 600 includes capturing the target frequency using a recording device. The recording device is positioned within the zone of the metamaterial. In some embodiments, isolating the target frequency comprises at least one of: amplifying the target frequency within the zone of the metamaterial and/or suppressing frequencies of the plurality of frequencies other than the target frequency. In some embodiments, a structure of the metamaterial passively isolates the target frequency.

In some embodiments, method 600 includes isolating the target frequency using a second metamaterial, the second metamaterial is positioned a distance from the metamaterial. In some embodiments, method 600 includes mapping a distribution of the insect using the target frequency isolated by the metamaterial and the second metamaterial. In some embodiments, the acoustic signal is obtained from a geographical area. In some embodiments, the sensing the target frequency of the insect comprises determining that an amplitude of target frequency is greater than a threshold.

In some embodiments, method 600 includes designing the metamaterial based on the target frequency. In some embodiments, method 600 includes designing the metamaterial was using iterative On Surface Radiation Conditions. In some embodiments, method 600 includes capturing a recording of the target frequency with a recording device; and transmitting the recording towards a computing device.

In some embodiments, the metamaterial comprises a body and a target zone. In some embodiments, the body comprises a plurality of chambers that amplify the target frequency in the target zone. In some embodiments, the metamaterial comprises an array of columns and a target zone. In some embodiments, each column in the array of columns has an elliptical cross-section. In some embodiments, a definition or a location of each elliptical cross-section amplifies the target frequency in the target zone. In some embodiments, the target zone comprises a gap between a first column and a second column in the array of columns. In some embodiments, the plurality of frequencies includes a second target frequency and the method 600 includes isolating the second target frequency from the plurality of frequencies using the metamaterial.

In some embodiments, the developed metamaterial may perform better when there is physical contact between the metamaterial and a monitored environment, e.g., due to more efficient sound transfer with solids than air. Accordingly, embodiments disclosed herein may be used for contact-based monitoring. In one example, the metamaterial performed better in identifying and monitoring pests beneath a tree truck when the metamaterial was in physical contact with the tree trunk (or a bee hive attached to the tree trunk). Accordingly, aspects of the present disclosure may be used to detect inside activity under the bark of a tree or inside a plant, or to monitor frequencies within a beehive by ensuring solid contact between the metamaterial and the tree or structure. Accordingly, aspects of the present disclosure may be used for open-field and/or contact-base monitoring.

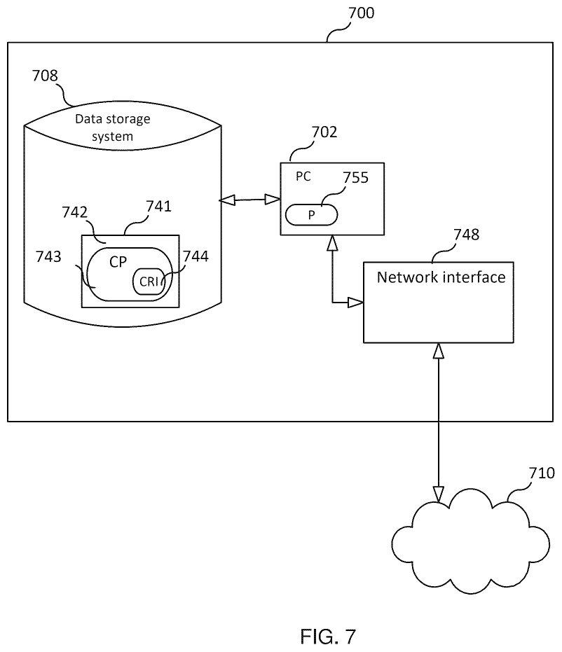

FIG. 7 is a block diagram of an apparatus 700, according to some embodiments. An apparatus 700 (e.g., computing device 113 or central computing system 201) performs the methods and all embodiments described above. As shown in FIG. 7, the apparatus may comprise: processing circuitry (PC) 702, which may include one or more processors (P) 755 (e.g., a general purpose microprocessor and/or one or more other processors, such as an application specific integrated circuit (ASIC), field-programmable gate arrays (FPGAs), and the like); a network interface 748 for enabling the apparatus to transmit data to and receive data from other devices connected to a network 710 (e.g., an Internet Protocol (IP) network such as the Internet) to which network interface 748 is connected; and a local storage unit (a.k.a., “data storage system”) 708, which may include one or more non-volatile storage devices and/or one or more volatile storage devices. In embodiments where PC 702 includes a programmable processor, a computer program product (CPP) 741 may be provided. CPP 741 includes a computer readable medium (CRM) 742 storing a computer program (CP) 743 comprising computer readable instructions (CRI) 744. CRM 742 may be a non-transitory computer readable medium, such as, magnetic media (e.g., a hard disk), optical media, memory devices (e.g., random access memory, flash memory), and the like. In some embodiments, the CRI 744 of computer program 743 is configured such that when executed by PC 702, the CRI causes the apparatus to perform steps described herein (e.g., steps described herein with reference to the flow charts). In other embodiments, the apparatus may be configured to perform steps described herein without the need for code. That is, for example, PC 702 may consist merely of one or more ASICs. Hence, the features of the embodiments described herein may be implemented in hardware and/or software.

Below is a concise description of certain embodiments.
A1. A method for sensing a target frequency of an insect, the method comprising:
   obtaining an acoustic signal comprising a plurality of frequencies, wherein the plurality of frequencies includes the target frequency;
   isolating the target frequency from the plurality of frequencies using a metamaterial; and
   sensing the target frequency of the insect based on the isolating.
A2. The method of embodiment 1, wherein the insect is a species of bee.
A3. The method of embodiment A1, further comprising:
   identifying, in response to sensing the target frequency of the insect, at least one of: a location of the insect, a behavior associated with the insect, a species of the insect, a population of the insect, or a health condition associated with the insect.
A4.The method of embodiment A1, wherein isolating comprises isolating the target frequency in a zone of the metamaterial.
A5.The method of embodiment A4, further comprising:
   capturing the target frequency using a recording device, wherein the recording device is positioned within the zone of the metamaterial.
A6. The method of embodiment A4, wherein isolating the target frequency comprises at least one of: amplifying the target frequency within the zone of the metamaterial and/or suppressing frequencies of the plurality of frequencies other than the target frequency.
A7. The method of embodiment A4, wherein a structure of the metamaterial passively isolates the target frequency.
A8. The method of embodiment A1, further comprising:
   isolating the target frequency using a second metamaterial, wherein the second metamaterial is positioned a distance from the metamaterial.
A9. The method of embodiment A8, further comprising:
   mapping a distribution of the insect using the target frequency isolated by the metamaterial and the second metamaterial.
A10. The method of embodiment A1, wherein the acoustic signal is obtained from a geographical area.
A11. The method of embodiment A1, wherein the sensing the target frequency of the insect comprises determining that an amplitude of target frequency is greater than a threshold.
A12. The method of embodiment A1, further comprising:
   designing the metamaterial based on the target frequency.
A13. The method of embodiment A1, further comprising:
   designing the metamaterial was using iterative On Surface Radiation Conditions.
A14. The method of embodiment A1, further comprising:
   capturing a recording of the target frequency with a recording device; and
   transmitting the recording towards a computing device.
A15. The sensing device of embodiment A1, wherein the metamaterial comprises a body and a target zone.
A16. The sensing device of embodiment A15, wherein the body comprises a plurality of chambers that amplify the target frequency in the target zone.
A17. The sensing device of embodiment A1, wherein the metamaterial comprises an array of columns and a target zone.
A18. The sensing device of embodiment A1, wherein each column in the array of columns has an elliptical cross-section.
A19. The sensing device of embodiment A18, wherein a definition or a location of each elliptical cross-section amplifies the target frequency in the target zone.
A20. The sensing device of embodiment A19, wherein the target zone comprises a gap between a first column and a second column in the array of columns.
A21. The sensing device of embodiment A1, wherein the plurality of frequencies includes a second target frequency and the method further comprises:
   isolating the second target frequency from the plurality of frequencies using the metamaterial.
B1. A sensing device comprising:
   a metamaterial designed to isolate a target frequency corresponding to an insect.
B2.The sensing device of embodiment B1, further comprising at least one of a recording device or a computing device.
B3.The sensing device of embodiment B1, wherein the metamaterial is designed based on the target frequency.
B4. The sensing device of embodiment B1, wherein the metamaterial is designed using iterative On Surface Radiation Conditions.
B5.The sensing device of embodiment B1, wherein the metamaterial comprises a body and a target zone.
B6.The sensing device of embodiment B5, wherein the body comprises a plurality of chambers that amplify the target frequency in the target zone.
B7.The sensing device of embodiment B1, wherein the metamaterial comprises an array of columns and a target zone.
B8.The sensing device of embodiment B7, wherein each column in the array of columns has an elliptical cross-section.
B9.The sensing device of embodiment B8, wherein a definition or a location of each elliptical cross-section amplifies the target frequency in the target zone.
B10. The sensing device of embodiment B9, wherein the target zone comprises a gap between a first column and a second column in the array of columns.
B11. The sensing device of embodiment B1, wherein the metamaterial is designed to isolate a second target frequency corresponding to a second insect.
B12. The sensing device of embodiment B11, wherein the metamaterial comprises a plurality of target zones including a first target zone associated with the target frequency and a second target zone associated with the second target frequency.
C1.A metamaterial designed to isolate a target frequency corresponding to an insect.
C2.The metamaterial of embodiment C1, wherein the metamaterial is designed based on the target frequency.
C3. The metamaterial of embodiment C1, wherein the metamaterial is designed using iterative On Surface Radiation Conditions.
C4.The metamaterial of embodiment C1, wherein the metamaterial comprises a body and a target zone.
C5.The metamaterial of embodiment C4, wherein the body comprises a plurality of chambers that amplify the target frequency in the target zone.
C6.The metamaterial of embodiment C1, wherein the metamaterial comprises an array of columns and a target zone.
C7.The metamaterial of embodiment C6, wherein each column in the array of columns has an elliptical cross-section.
C8.The metamaterial of embodiment C7, wherein a definition or a location of each elliptical cross-section amplifies the target frequency in the target zone.
C9.The metamaterial of embodiment C8, wherein the target zone comprises a gap between a first column and a second column in the array of columns.
C10 The metamaterial of embodiment C1, wherein the metamaterial is designed to isolate a second target frequency corresponding to a second insect.
C11. The metamaterial of embodiment C10, wherein the metamaterial comprises a plurality of target zones including a first target zone associated with the target frequency and a second target zone associated with the second target frequency.
D1. A computing device, the computing device comprising:
   a processor; and
   a computer program product storing instructions that, when executed by the processor, causes the computing device to perform a process comprising:
   obtaining an acoustic signal associated with an insect; and
   identifying, based on the acoustic signal, at least one of: a location of the insect, a behavior associated with the insect, a species of the insect, a population of the insect, or a health condition associated with the insect.
D2. The computing device of embodiment D1, wherein the acoustic signal is obtained from a recording device and the recording device is disposed within a target zone of a metamaterial.
D3. The computing device of embodiment D1, wherein the acoustic signal is obtained from another computing device.
D4. The computing device of embodiment D1, further comprising:
   generating a recording of the acoustic signal.
D5. The computing device of embodiment D4, wherein generating the recording of the acoustic signal comprises:
   determining an amplitude of the acoustic signal is greater than a threshold, wherein the recording of the acoustic signal is generated as a result of the amplitude being greater than the threshold.

While various embodiments of the present disclosure are described herein, it should be understood that they have been presented by way of example only, and not limitation. Thus, the breadth and scope of the present disclosure should not be limited by any of the above-described exemplary embodiments. Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. Any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel. That is, the steps of any methods disclosed herein do not have to be performed in the exact order disclosed, unless a step is explicitly described as following or preceding another step and/or where it is implicit that a step must follow or precede another step.

1. A method for sensing a target frequency of an insect, the method comprising:
obtaining an acoustic signal comprising a plurality of frequencies, wherein the plurality of frequencies includes the target frequency;
isolating the target frequency from the plurality of frequencies using a metamaterial; and
sensing the target frequency of the insect based on the isolating.

2. The method of claim 1, wherein the insect is a species of bee.

3. The method of claim 1, further comprising:
identifying, in response to sensing the target frequency of the insect, at least one of: a location of the insect, a behavior associated with the insect, a species of the insect, a population of the insect, or a health condition associated with the insect.

4. The method of claim 1, wherein isolating comprises isolating the target frequency in a zone of the metamaterial.

5. The method of claim 4, further comprising:
capturing the target frequency using a recording device, wherein the recording device is positioned within the zone of the metamaterial.

6. The method of claim 4, wherein isolating the target frequency comprises at least one of: amplifying the target frequency within the zone of the metamaterial and/or suppressing frequencies of the plurality of frequencies other than the target frequency.

7. The method of claim 4, wherein a structure of the metamaterial passively isolates the target frequency.

8. The method of claim 1, further comprising:
isolating the target frequency using a second metamaterial, wherein the second metamaterial is positioned a distance from the metamaterial.

9. The method of claim 8, further comprising:
mapping a distribution of the insect using the target frequency isolated by the metamaterial and the second metamaterial.

10. The method of claim 1, wherein the acoustic signal is obtained from a geographical area.

11. The method of claim 1, wherein the sensing the target frequency of the insect comprises determining that an amplitude of target frequency is greater than a threshold.

12. The method of claim 1, further comprising:
designing the metamaterial based on the target frequency.

13. The method of claim 1, further comprising:
designing the metamaterial was using iterative On Surface Radiation Conditions.

14. The method of claim 1, further comprising:
capturing a recording of the target frequency with a recording device; and
transmitting the recording towards a computing device.

15. The method of claim 1, wherein the metamaterial comprises a body and a target zone.

16. The method of claim 15, wherein the body comprises a plurality of chambers that amplify the target frequency in the target zone.

17. The method of claim 1, wherein the metamaterial comprises an array of columns and a target zone.

18. The method of claim 17, wherein each column in the array of columns has an elliptical cross-section.

19. The method of claim 18, wherein a definition or a location of each elliptical cross-section amplifies the target frequency in the target zone.

20. The method of claim 19, wherein the target zone comprises a gap between a first column and a second column in the array of columns.

21. The method of claim 1, wherein the plurality of frequencies includes a second target frequency and the method further comprises:
isolating the second target frequency from the plurality of frequencies using the metamaterial.

22. A computing device, the computing device comprising:
a processor; and
a computer program product storing instructions that, when executed by the processor, causes the computing device to:
obtain an acoustic signal associated with an insect, wherein the acoustic signal is obtained from a recording device and the recording device is disposed within a target zone of a metamaterial; and
identify, based on the acoustic signal, at least one of: a location of the insect, a behavior associated with the insect, a species of the insect, a population of the insect, or a health condition associated with the insect.

23. The computing device of claim 22, wherein the acoustic signal is obtained from another computing device.

24. The computing device of claim 22, comprising a computer program product storing further instructions that, when executed by the processor, causes the computing device to:
generate a recording of the acoustic signal.

25. The computing device of claim 24, wherein the generate the recording of the acoustic signal comprises determining that an amplitude of the acoustic signal is greater than a threshold, wherein the recording of the acoustic signal is generated as a result of the determination that the amplitude is greater than the threshold.
